(19) United States
(12) Patent Application Publication
(10) Pub. No.: US 2003/0154195 A1
(43) Pub. Date: Aug. 14, 2003

(54) Method for adapting information to suit a user's behaviour or preferences with automatic optimisation

(76) Inventors: Erik Wallin, Stockholm (SE); Erik Herou, Jarfalla (SE); Mikael Uverbrandt, Stockholm (SE); Filip Asp, Huddinge (SE); Henrik Dyberg, Stockholm (SE)

Correspondence Address: NIXON & VANDERHYE, PC, 1100 N GLEBE ROAD, 8TH FLOOR, ARLINGTON, VA, 22201-4714, US

(21) Appl. No.: 10/333,470

(22) PCT Filed: Jul. 16, 2001
(86) PCT No.: PCT/SE01/01636

(30) Foreign Application Priority Data
Jul. 20, 2000 (SE) 00027276

(51) Int. Cl. G06F 7/00

(52) U.S. Cl. 707/3

(57) ABSTRACT

The present invention relates to a method for adapting information to suit a user's behaviour or preferences. The adaptation takes place with automatic optimisation by said user being identified and assigned a group affiliation, in that information is selected based on said group affiliation, in that said user's behaviour is registered, in that said user's behaviour and/or history is analysed, and in that the result of said analysis and other available information is utilised to refine the next information selection for said user.

### TECHNICAL FIELD

The present invention relates to a method and a system for assigning a user a group affiliation and refining the group affiliation in accordance with the behaviour of the user. The invention divides users into groups and supplies a specific presentation of information to each group. The invention is intended primarily for use in server environments for information available on the Internet.

The information is typically transmitted from a supplier of information and services to the client system of an end user for receipt of information, but the system is not limited to this model.

### BACKGROUND ART

Distribution Problems of the Classical Information Services in New Guise

What differentiates the Internet situation from the distribution situation of previous information services is perhaps first and foremost the enormous range of easily available information and the competition between various information services. In order to effectivise communication it must be possible to adapt the information depending on which user is being communicated with. There is considerable risk of the user missing information of interest to his individual preferences in the vast amount of information communicated. For the supplier of information this may mean fewer satisfied users, resulting in the services of the information supplier not being demanded.

Offer Information Suited to the End User

If the server system can in some way adapt the information presented so that what is expected to be of most interest to the user is seen first and most clearly, the likelihood increases of the user finding the information service useful and making use of it in such a manner that the goal of the information supplier is fulfilled.

Several different isolated systems exist for suiting information to a user's preferences and performing a certain division of users. Patent publications WO 98/02835, WO 99/16003, U.S. Pat. No. 5,862,325 and U.S. Pat. No. 5,956,693 describe such a system but they are unable to divide the users into several different groups to optimize group affiliation in a controlled and automatic manner. The systems permit various users to be assigned different user categories either by a system administrator or manually by the users themselves. Manual assignment is achieved by the user expressly choosing various area of interest or objects related to various areas of interest. System-administrative assignment occurs either by a system operator selecting manually which users shall belong to a group or by the system itself choosing affiliation by means of various statistical methods.

The publication “The Sport Web Case: Design and Prototype of a System for E-commerce and Research”, by Christian Persson, Bo Lennstrand and Erik O. Wallin, published in connection with The third international Conference on Telecommunications and Information Markets (COTIM-99) in Providence, R.I., USA, Sep. 26-29 1999 and the publication “Web Metrics—Design Specifications of Web-based System for Personalization with ‘Bifurcation’”, by Erik Wallin, Christian Persson and Bo Lennstrand, published in connection with the TAGA 2000 Colorado Springs conference, Colorado Springs, Colo., USA, Apr. 2-5, 2000, describe a system in which a simpler form of group division is used.

Technical Problems

Taking into account the background art as described above, it is a technical problem to automatically register and analyse the user's behaviour and any expressed preferences in order to optimise assignment of group affiliation and to sufficiently quickly, already after one visit of the user, to be able to find a group affiliation that will offer the user relevant information.

Solution

With the object of solving one or more of the technical problems mentioned above, the point of departure of the invention is a system and a method for adapting information to a user's behaviour or preferences.

In accordance with the invention the adaptation takes place with automatic optimisation by said user being identified and assigned a group affiliation, in that information is selected based on said group affiliation, in that said user's behaviour is registered, in that said user's behaviour and/or history is analysed, and in that the result of said analysis and other available information is utilised to refine the next information selection for said user.

Group affiliation may be assigned to the user permanently or temporarily.

The group affiliation division is performed on the basis of information gathered when the user has been identified by an internal system, other information from the internal system or other external systems, the observed behaviour of the user and/or preferences expressed by the user.

The internal system uses exchangeable algorithms from a first set of algorithms in order to analyse the user's behaviour and govern group affiliation division.

By means of various probability values for presentations, in combination with exchangeable group affiliation division algorithms from a second set of algorithms, the system can automatically test various information presentations and register the outcome, and alter the group affiliation division for a user in order to refine the group affiliation division for a user.

Advantages

The advantages that can primarily be deemed to characterise a method in accordance with the present invention are that it offers the possibility of automatically optimising group affiliation of users, thereby optimising information selection and presentation.

The invention enables the behaviour of different users to be ascertained, thereby enabling the layout of information services to be optimised.

The design of the invention ensures that the system reacts extremely quickly to a user's behaviour or preferences. Already after one user visit the system can provide the user with a relevant group affiliation.

The invention is independent of technical platforms and can deal with environments in which different media and platforms are mixed.

### BRIEF DESCRIPTION OF THE DRAWINGS

A method, software products, a carrier medium and a computer-readable medium in accordance with the present invention will now be described by way of example with reference to the accompanying drawings, in which

FIG. 1 shows schematically and greatly simplified, the concatenation of the system,

FIG. 2 shows how the user's group affiliation is assigned using information from various sources and information from the internal system, and

FIG. 3 shows how the system compares a user's behaviour with predetermined behaviour for group affiliation stored by the system.

### DESCRIPTION OF PREFERRED EMBODIMENTS

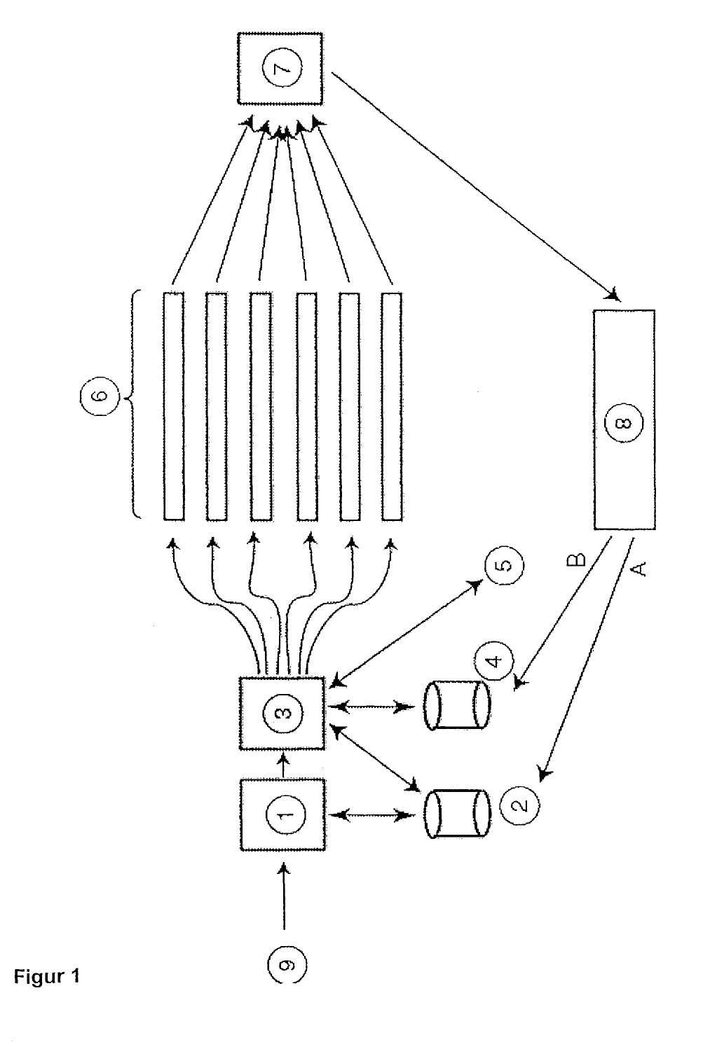

The present invention relates to a method for assigning users a group affiliation. FIG. 1 is intended to show that the first step is for the user 9 to be identified 1 with the aid of user information from either an external system or an internal system 2. In the differentiating step 3 the user is assigned a group affiliation 6 with the aid of exchangeable algorithms from a first set of algorithms 4 and possibly information from external sources 5 and user information 2. An analysis is performed of the user's documents 7. The result of the analysis updates 8 the user information 2, A and/or the exchangeable algorithms 4, B.

Identification

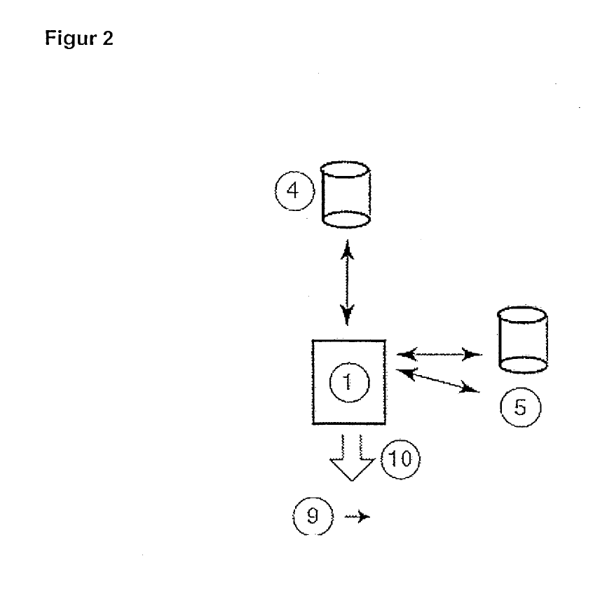

The internal system 1 identifies 10 the user 9 with the aid of the information supplied by the medium used or by the user himself stating his identity, as shown in FIGS. 1 and 2. Cookies, ip numbers, etc. can be used for web readers on the Internet. Further information from other external sources may also be used 5. The internal system uses databases 4 to store information about the individual users, such as identification information, implicitly and explicitly produced preferences and behaviour. The databases are used, for instance, at identification.

Differentiation

The next step is for the individual user to be assigned group affiliation where the presentation of information is controlled. The internal system uses a control algorithm 3 to select differentiation algorithm 4. The control algorithm chooses between several different differentiating algorithms in accordance with criteria dictated in the control algorithm, e.g. date. The differentiating algorithm selected can use information from the user database 2 about the user's preferences or behaviour and/or information from other sources 5. No limits exist as to the type of data source. The differentiating algorithm selects a group affiliation 6 and thus also a presentation for the user concerned. The relevant regulation, other information from the user database or other sources and selected presentation are stored in a session object, a sustainer. A presentation may be a reference to an information source, e.g. a URL. The internal system supports an unlimited number of presentations. A quantity of system parameters also pertain to the presentation, their values varying depending on which presentation is used.

Updating

The user's documents and results are compiled in the analysis part 7 with the aid of mathematical and/or statistical methods. Which information objects the user has interacted with is stored for subsequent analysis.

When a session is deemed to be over, either when the user actively terminates it or when the sustainer has not been used by the user for a certain length of time, the stored events indicating interest shall be combined with the existing user information. This is performed by the updating function 8 which updates the behaviour and preferences A of the individual user and/or the exchangeable algorithms 4, B.

Differentiating Algorithms

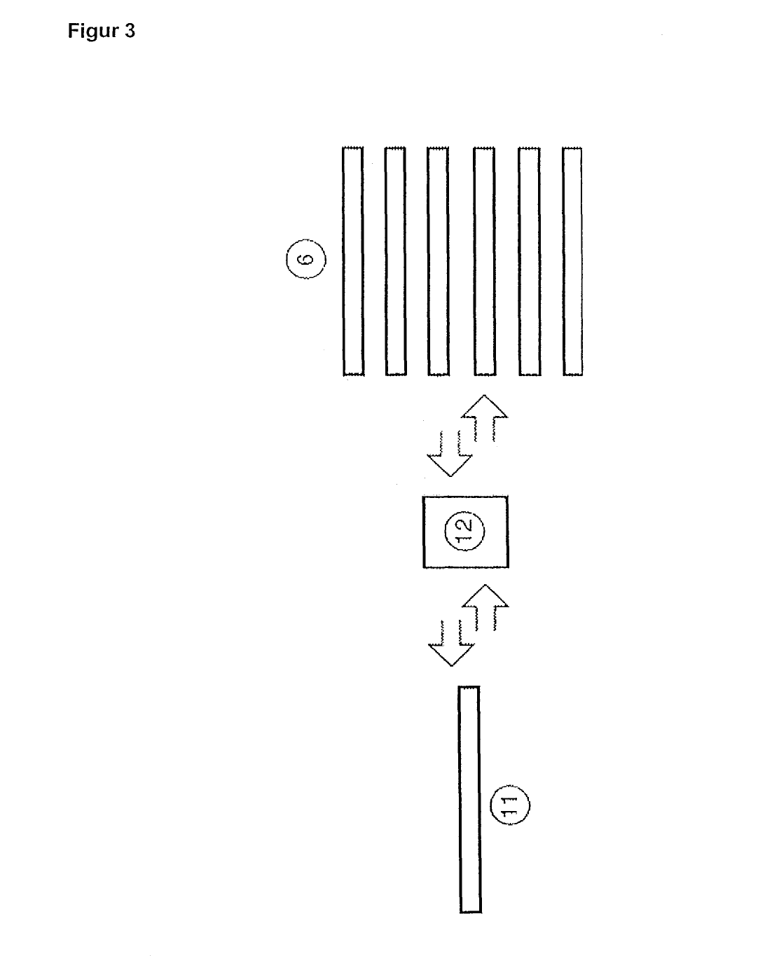

The user-segmented differentiation will be illustrated with reference to FIG. 3. An exchangeable algorithm from a second set of algorithms 12 compares the user's stored behaviour and preferences 11 with one or more predetermined behaviours and preferences 6 in order to select one of the presentations. The predetermined behaviours and preferences may be influenced by other data sources and may be changed in real time. Some examples of differentiating algorithms are given below:

Variable Probabilities

In accordance with various probability values the algorithm distributes the users to the various presentations in combination with the use of user-segmented differentiation, for instance.

Single-Optimisation

The algorithm distributes the users stochastically between two or more presentations. The algorithm measures the differences in outcome over a predetermined period of time between the various presentations, and selects the best presentation after the predetermined period of time to all users.

Multi-Optimisation

The algorithm distributes the users either stochastically or via predetermined behaviours and preferences between a first set of different presentations. The user's outcome is analysed on the basis of a set of desirable outcomes and a second set of presentations is used. The possible number of levels of presentations and desired outcomes is unlimited.

Complex Algorithms

The system allows combinations of the above algorithms, thereby offering several possibilities of adapting the system to different situations.

User-Behaviour—Vectors

The user-behaviour is stored in database records that can be likened to vectors. Each information object has one or more vectors of its own in which the agreement of the product with various segmented properties is stored. In the same way each user has a vector for each type of vector the information objects have, with the same appearance as regards data field. This is to enable comparison of the user's set of vectors with that of the information objects, which results in a deviation point. Less points indicate less deviation and thus an information object that matches the user better. The database contains a table for each type of information object vector and a table for each type of user vector.

The appearance of different segmenting properties for the vector in, for instance, a system where cinema tickets are to be sold may be for an information object (an individual film): Action, Romance, Drama, Family, Thriller, Science-fiction. The information object usually has binary values for the various categories.

The user has a similar vector where the fields contain liquidity index values which are constantly updated depending on which information object the user has been exposed to or has chosen. The liquidity index values can be interpreted as probabilities indicating the user's tendency to choose a specific information object.

Sessions-Sustainer

Each user's set of vectors, specific settings for the differentiation and settings for methods as to how deviation points between the user's sets of vectors and the information object's sets of vectors shall operate must be retained during a visit for each individual user since this quantity of data is frequently required by the system. A method is also needed for storing the interest shown by the user for information objects. Two forms of interest are usually displayed by the user: exposure or purchase of an information object. Other forms of interest indications events may exist dependent on the implementation in question, but these two are typical examples.

The system uses two types of sessions-sustainers. These are objects which, depending on implementation, can use the server's RAM memory, for instance, or a database schedule to store information. One sort of sustainer is used to store the user's set of vectors and settings for the visit, while the other sort stores information about interest displayed by the user.

When a new user enters the system for the first time, or after having been disconnected for a considerable time, this user is assigned the necessary new sessions-sustainers. This usually means that new objects or records in a database table are created. The system then has functions which are called up each time the user displays an interest. The functions then operate with a sustainer to store the behaviour for subsequent use. Equivalent functions also exist for storing and collecting settings for the visit.

A general interest-sustainer shall have methods for creating an object, linking this to a particular visit session, which is identified with a unique text string or a number, and for storing the event “exposure” of an information object and storing the event “purchase” of an information object. The time shall also be saved upon storing.

The present invention also relates to a computer program product comprising computer program codes which, when executed by a computer, is designed to perform necessary operations to assign a user a group affiliation in accordance with the method of the invention.

The present invention also relates to a carrier medium, that carries computer program codes in accordance with a computer program product of the invention, as well as a medium readable by a computer, in which computer program codes in accordance with the invention are stored.

It should be understood that the present invention is not limited to the embodiments described above by way of example, but may undergo modifications within the scope of the inventive concept as illustrated in the appended claims.

1. A method for adapting information to suit a user's behaviour or preferences, characterized in that said adaptation takes place with automatic optimisation by said user being identified and assigned a group affiliation, in that information is selected based on said group affiliation, in that said user's behaviour is registered, in that said user's behaviour and/or history is analysed, and in that the result of said analysis and other available information is utilised to refine the next information selection for said user.

2. A method as claimed in claim 1, characterized in that said group affiliation is assigned permanently to said user.

3. A method as claimed in claim 1, characterized in that said group affiliation is assigned temporarily to said user.

4. A method as claimed in claim 1, characterized in that said group affiliation is assigned with the aid of information used to uniquely identify said user and/or other information that has been gathered at the time of identification.

5. A method as claimed in claim 1, characterized in that said group affiliation is assigned with the aid of information from an external system.

6. A method as claimed in claim 1, characterized in that said group affiliation is assigned with the aid of information from an internal system.

7. A method as claimed in claim 1, characterized in that said group affiliation is assigned with the aid of unique information about said user from an internal system.

8. A method as claimed in claim 7, characterized in that said group affiliation is assigned with the aid of information expressly given by said user concerning preferences.

9. A method as claimed in claim 7, characterized in that said group affiliation is assigned with the aid of behaviour of said user observed by said internal systems.

10. A method as claimed in claim 9, characterized in that said observation consists of comparing stored behaviour of said user and predetermined behaviour for said group affiliations stored by said internal systems.

11. A method as claimed in claim 10, characterized in that said comparison consists of said group affiliation being assigned with the aid of arbitrary and exchangeable algorithm.

12. A method as claimed in one or more of claims 1 to 11, characterized in that a combination of one or more of claims 2 to 11 is used in said internal systems for assigning group affiliation.

13. A method as claimed in any one of claims 1-11, characterized in that probability values are used in said internal systems in combination with one or more of claims 2 to 11 for assigning group affiliation, and in that the probability values are set by said internal systems or by some other system or person.

14. A method as claimed in one or more of claims 1 to 13, characterized in that those information objects that said user has requested or been exposed to are registered in said internal systems, and in that said information objects are used in said registration at said analysis.

15. A method as claimed in one or more of claims 1 to 14, characterized in that said analysis comprises an exchangeable algorithm from a first set of algorithms and in that, with the aid of said registered information objects, said exchangeable algorithm finds the representation of the behaviour of said user regarding a specific period of time, event or several events.

16. A method as claimed in one or more of claims 1 to 15, characterized in that said systems' information about the behaviour of said user is updated and refined with an exchangeable algorithm from a second set of algorithms with the aid of the result of said analysis.

17. A computer program product, characterized in that said computer program product comprising computer program codes which, when executed by a computer is designed to perform necessary operations to assign a user a group affiliation in accordance with a method as claimed in any one of claims 1 to 16.

18. A carrier medium, characterized in that said medium carries computer program codes as claimed in claim 17.

19. A medium readable by a computer, characterized in that computer program codes as claimed in claim 17 are stored on said medium readable by a computer.
